(19) United States
(12) Patent Application Publication
(10) Pub. No.: US 2025/0332952 A1
(43) Pub. Date: Oct. 30, 2025

(54) BATTERY ATTACHMENT APPARATUS AND VEHICLE

(71) Applicant: Isuzu Motors Limited, Yokohama-shi (JP)

(72) Inventor: Takashi MIZUKI, Fujisawa-shi (JP)

(73) Assignee: Isuzu Motors Limited, Yokohama-shi (JP)

(21) Appl. No.: 19/058,108

(22) Filed: Feb. 20, 2025

(30) Foreign Application Priority Data
Apr. 30, 2024 (JP) 2024-073919

(51) Int. Cl. B60L 53/80; B60L 50/60

(52) U.S. Cl. CPC B60L 53/80; B60L 50/66

(57) ABSTRACT

A battery attachment apparatus 1 of electric vehicle C according to the present disclosure includes: a first lock mechanism 30X and a second lock mechanism 30Y disposed at a first attachment position and a second attachment position of a storage part. A battery is stored, and configured to operate in conjunction with each other to fix the battery to the storage part, wherein the first lock mechanism 30X includes a first sensor 30cX configured to sense an operation of the first lock mechanism 30X and detect a lock completion of the battery based on an operation state of the first lock mechanism 30X. The second lock mechanism 30Y includes a second sensor 30cY configured to sense an operation of the second lock mechanism 30Y and detect an unlock completion of the battery based on an operation state of the second lock mechanism 30Y.

### TECHNICAL FIELD

The present disclosure relates to a battery attachment apparatus and a vehicle.

### BACKGROUND ART

In the related art, electric vehicles equipped with batteries (for example, electric automobiles and electric scooters) are known.

In recent years, such electric vehicles have increasingly adopted battery exchange systems. Such battery exchange systems are generally designed based on the concept that when the stored power of the battery mounted on a vehicle is depleted, the battery is exchanged with another battery fully charged at a battery exchange station, instead of charging the battery each time (see, for example, PTL 1).

### CITATION LIST

### Patent Literature

Japanese Patent Application No. 2023-134543

### SUMMARY OF INVENTION

### Technical Problem

In this type of battery exchange system, the operation of a lock mechanism (for example, see FIGS. 3, 4, and 5 described later) that supports and fixes the battery to the vehicle frame is typically controlled under the control of the ECU, and the battery is removed from the vehicle frame and/or attached to the vehicle frame.

At this time, the ECU establishes communication with the station system on the battery exchange station side, and then performs the exchange of the battery mounted on the vehicle in cooperation with the battery exchanger of the battery exchange station.

For this reason, this type of lock mechanism is commonly provided with a sensor to ensure safety during battery replacement. The ECU performs the battery replacement after detecting the completion of the battery unlocking using the sensor. The reason for this is that the vehicle or the battery may be damaged if the battery exchange machine on the battery exchange station side operates as usual to forcibly pull out the half-locked battery from the vehicle even though there is a failure (for example, a malfunction) in the lock mechanism during the unlocking process.

In the related art, this type of battery exchange system typically detects the lock state of the lock mechanism using only one sensor. However, if the system is provided with only one sensor and the ECU determines switch ON=lock and switch OFF=unlock based on the sensor signal, it may determine unlock even though the lock is not correctly released when the lock mechanism stops due to a failure or the like during the operation. If such an incorrect determination is made, a dangerous situation as described above may occur.

The present disclosure has been made in view of the above problems, and an object thereof is to provide a battery attachment apparatus and a vehicle that can accurately determine a holding state of a battery.

### Solution to Problem

To solve the above-described problems, a battery attachment apparatus according to the present invention includes a first lock mechanism and a second lock mechanism disposed at a first attachment position and a second attachment position of a storage part in which a battery is stored, and configured to operate in conjunction with each other to fix the battery to the storage part. The first lock mechanism includes a first sensor configured to sense an operation of the first lock mechanism and detect a lock completion of the battery based on an operation state of the first lock mechanism. The second lock mechanism includes a second sensor configured to sense an operation of the second lock mechanism and detect an unlock completion of the battery based on an operation state of the second lock mechanism.

### Advantageous Effects of Invention

According to the battery attachment apparatus of the present invention, it is possible to accurately determine the holding state of the battery.

### BRIEF DESCRIPTION OF DRAWINGS

FIG. 1 is a diagram illustrating an example of an attached position of a battery attachment apparatus;

FIG. 2 is a perspective view illustrating an example of an overall configuration of the battery attachment apparatus;

FIG. 3 is a diagram illustrating an example of a configuration of a lock mechanism (lock release state);

FIG. 4 is a diagram illustrating an example of a configuration of the lock mechanism (transition state);

FIG. 5 is a diagram illustrating an example of a configuration of the lock mechanism (locked state);

FIG. 6 is a diagram illustrating an example of a configuration of a battery;

FIG. 7 is a diagram illustrating an example of a configuration of a lock switch and an unlock switch provided in the lock mechanism;

FIG. 8 is a diagram illustrating an example of a configuration of a driving section of the lock mechanism;

FIG. 9 is a diagram illustrating an example of an operation procedure of the ECU; and

FIG. 10 is a diagram illustrating an example of an operation procedure of the ECU.

### DESCRIPTION OF EMBODIMENTS

Hereinafter, preferred embodiments of the present disclosure will be described in detail with reference to the accompanying drawings. In the present specification and drawings, components having substantially the same functions are denoted by the same reference numerals, and redundant descriptions are omitted.

Note that each figure illustrates a common orthogonal coordinate system (X, Y, Z) to clarify the positional relationship of each configuration. The positive direction of the Z-axis represents the vertically upward direction of the vehicle, the positive direction of the X-axis represents the forward direction of the vehicle, and the positive direction of the Y-axis represents the lateral direction of the vehicle.

Hereinafter, an exemplary configuration of a battery attachment apparatus (hereinafter, referred to as “battery attachment apparatus 1”) according to an embodiment of the present invention will be described.

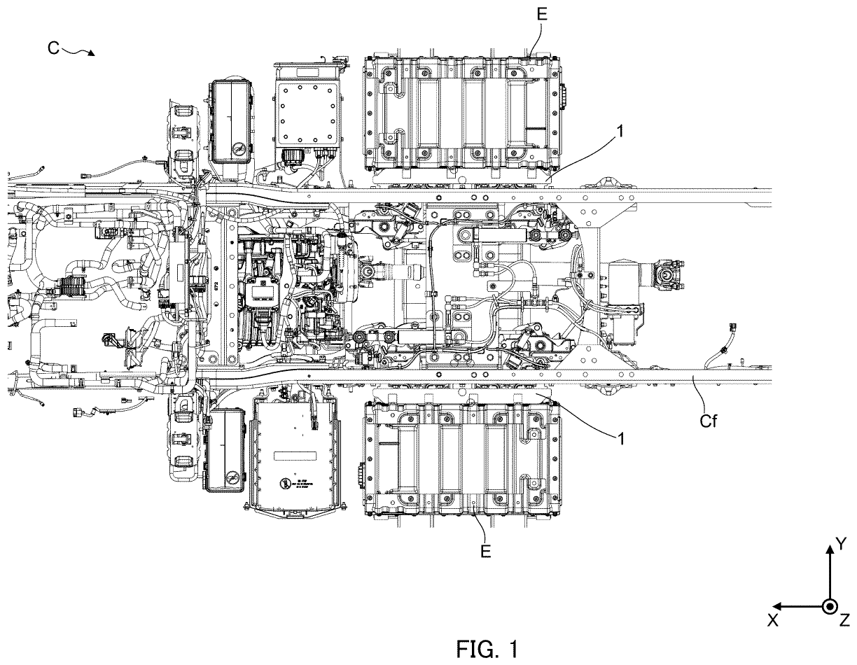

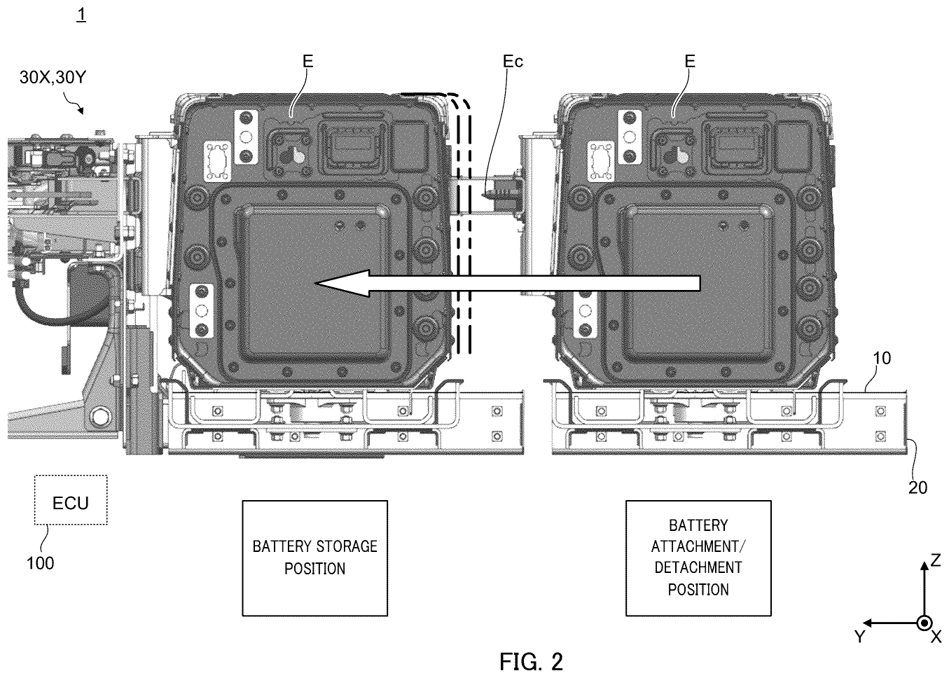

FIG. 1 is a diagram illustrating an example of an attached position of battery attachment apparatus 1. FIG. 2 is a diagram illustrating an example of an overall configuration of battery attachment apparatus 1.

Battery attachment apparatus 1 is mounted on vehicle C such as an electric vehicle or a hybrid vehicle, and holds a battery used as a drive power source for vehicle C. Note that, in FIG. 1, large vehicle C such as a truck is described as a suitable application example of battery attachment apparatus 1.

Battery attachment apparatus 1 holds battery E fixed to vehicle frame Cf of vehicle C, and allows battery E to be detachable from vehicle frame Cf of vehicle C as necessary, for example. Battery attachment apparatus 1 is attached, for example, to a side surface of vehicle frame Cf. Vehicle frame Cf (for example, a steel frame material having a U-shaped cross section) of vehicle C extends along the front-rear direction of vehicle C on both the left and right sides of vehicle C, and supports the vehicle body and various on-board devices.

Battery E is a high-voltage battery that supplies operating power for driving vehicle C. As battery E, for example, a 200 V class lithium-ion battery is used.

Note that, FIG. 1 illustrates two battery attachment apparatuses 1 that hold respective two batteries E attached to vehicle frame Cf. The following description assumes that two battery attachment apparatuses 1 have the same configuration, and as such only the configuration of battery attachment apparatus 1 mounted on the minus Y side (that is, the left side surface of vehicle C) will be described.

Battery attachment apparatus 1 includes, for example, mounting table 10 on which battery E is mounted, slide rail base 20 that supports mounting table 10 in a slidable manner, lock mechanisms 30X and 30Y that attach battery E to vehicle frame Cf, and ECU 100.

Slide rail base 20 is attached, for example, to the outer side surface (here, the right side surface) of vehicle frame Cf, and extends in the horizontal direction from vehicle frame Cf toward the outside of vehicle C (that is, the minus Y-direction side). Then, slide rail base 20 guides mounting table 10 in a slidable manner between the battery storage position and the battery attachment/detachment position in vehicle C.

Mounting table 10 is a base on which battery E is mounted, and is disposed, for example, to span between two guide members of slide rail base 20. Note that, mounting table 10 is slidable only along the +Y direction along slide rail base 20.

FIG. 2 illustrates a state in which mounting table 10 is slid from the battery attachment/detachment position to the battery storage position.

In battery attachment apparatus 1 according to the present embodiment, when accommodating battery E in vehicle C, battery E is placed on mounting table 10 when mounting table 10 is in the battery attachment/detachment position. Then, battery E placed on mounting table 10 is slid on slide rail base 20 and guided from the battery attachment/detachment position to the battery storage position. Then, battery E is locked to vehicle frame Cf at the battery storage position using lock mechanisms 30X and 30Y. At this time, the storage of battery E in vehicle C is completed when terminal part Ec of battery E is connected to a connector in vehicle C.

On the other hand, when removing battery E from vehicle C in battery attachment apparatus 1 according to the present embodiment, lock mechanisms 30X and 30Y are driven to release the locked state of battery E to vehicle frame Cf. Then, battery E placed on mounting table 10 is slid on slide rail base 20 and guided to the battery attachment/detachment position from the battery storage position in vehicle C. Then, battery E is lifted by a battery exchanger of a battery exchange station at the battery attachment/detachment position and removed from vehicle C, for example.

Note that, for an example of the operation of the battery exchanger in the battery exchange station, refer to, for example, PTL 1 of the prior application by the applicant of the present application.

Next, a specific configuration of lock mechanisms 30X and 30Y will be described.

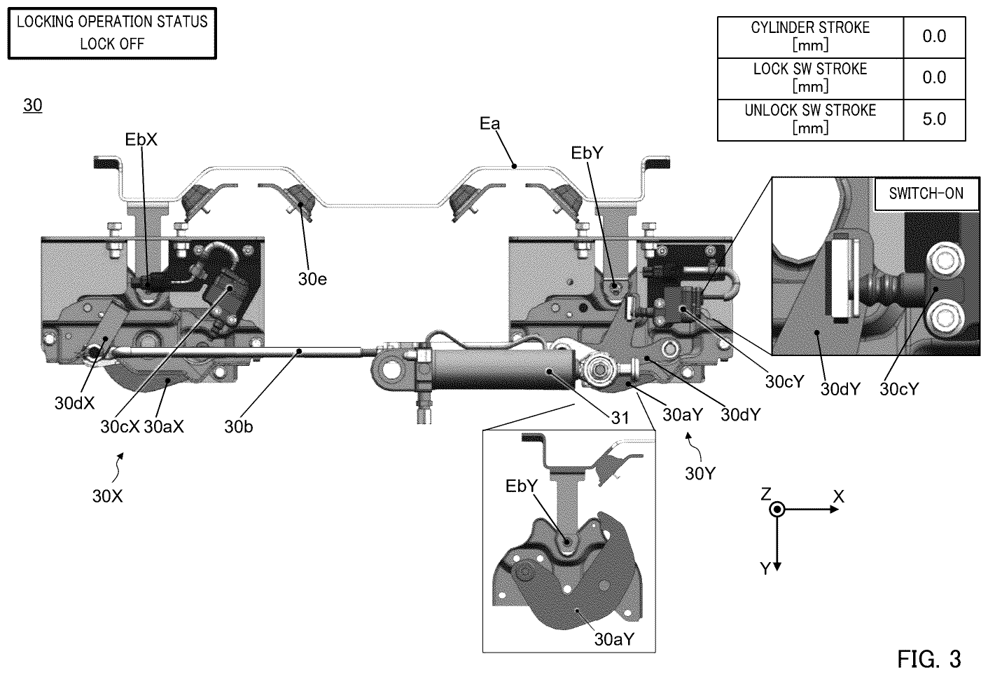

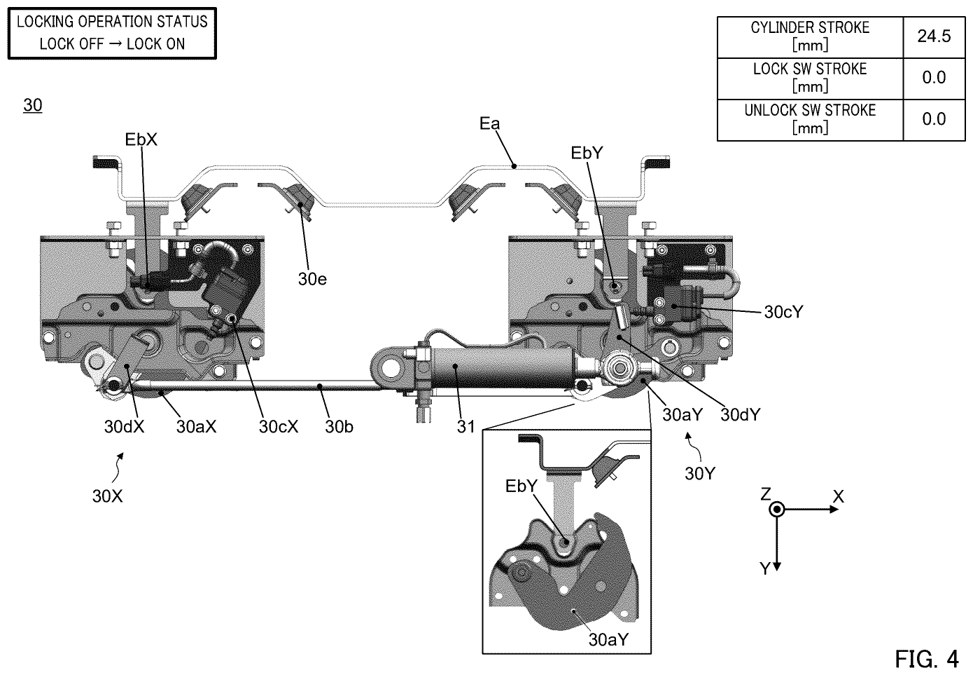

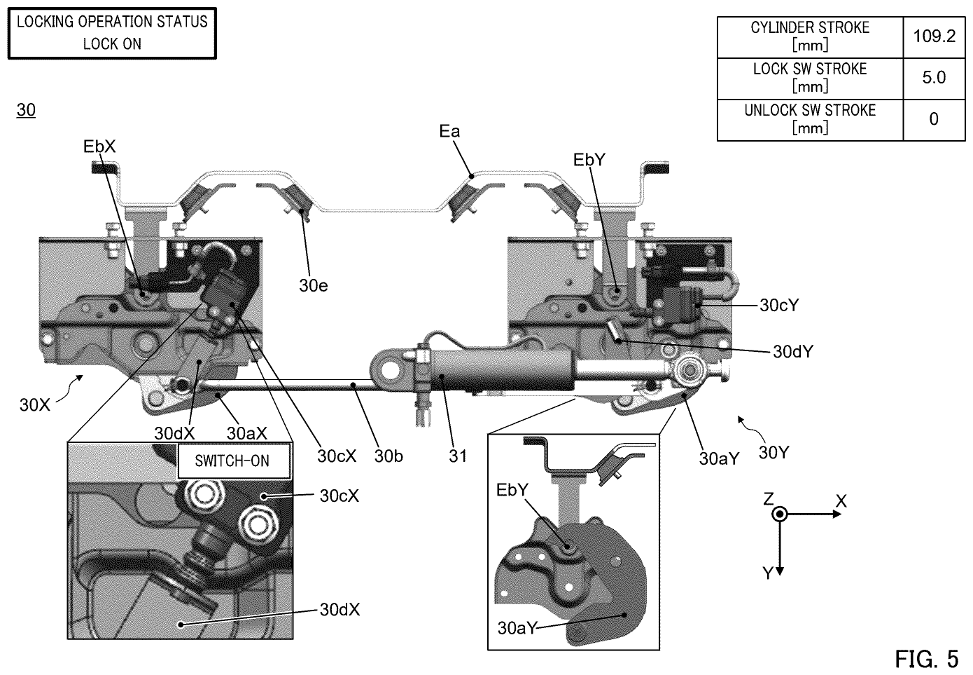

FIGS. 3, 4, and 5 are diagrams (plan views) illustrating an example of a configuration of lock mechanisms 30X and 30Y. FIG. 3 illustrates an unlocked state, FIG. 4 illustrates a transition state between a locked state and an unlocked state, and FIG. 5 illustrates an unlocked state. Note that, in FIGS. 3, 4, and 5, only battery bracket Ea attached to the side surface of battery E is illustrated and the illustration of battery E is omitted.

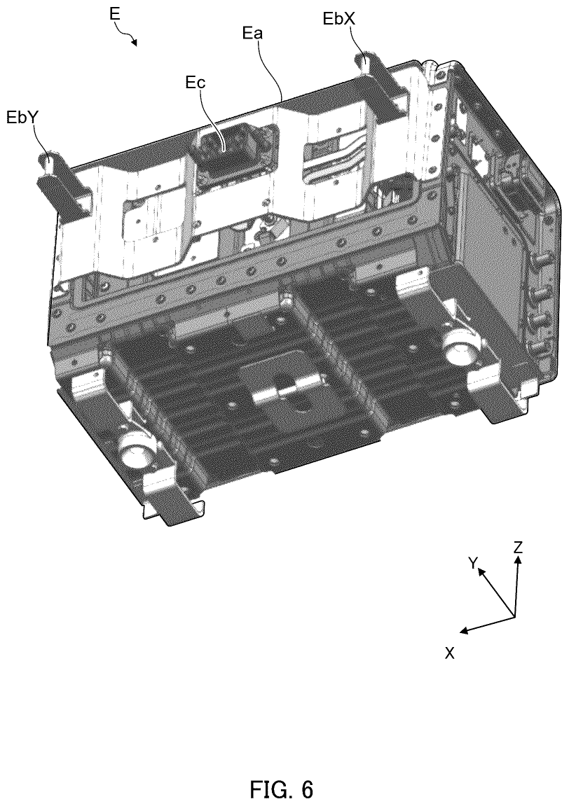

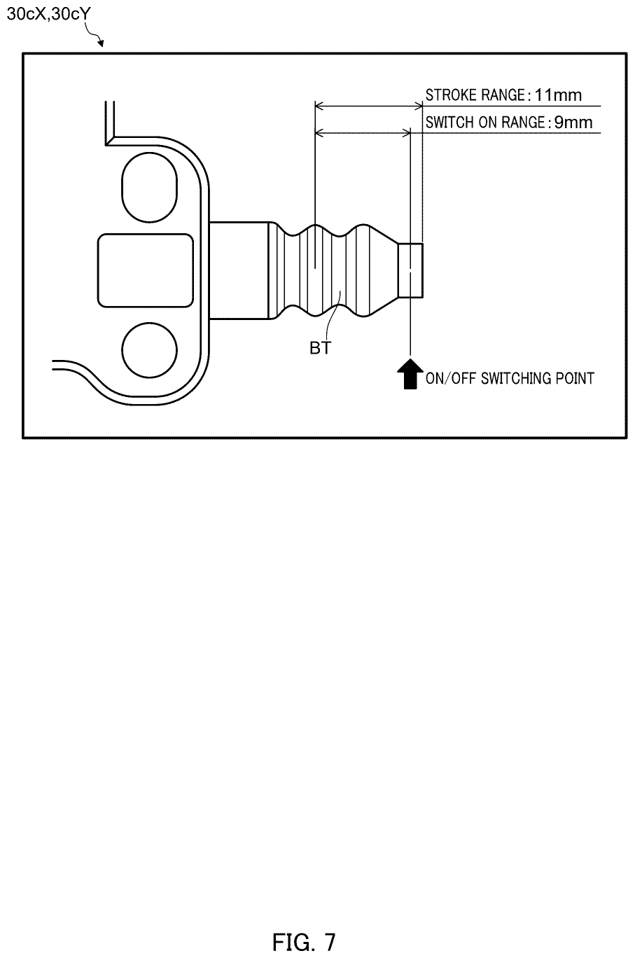

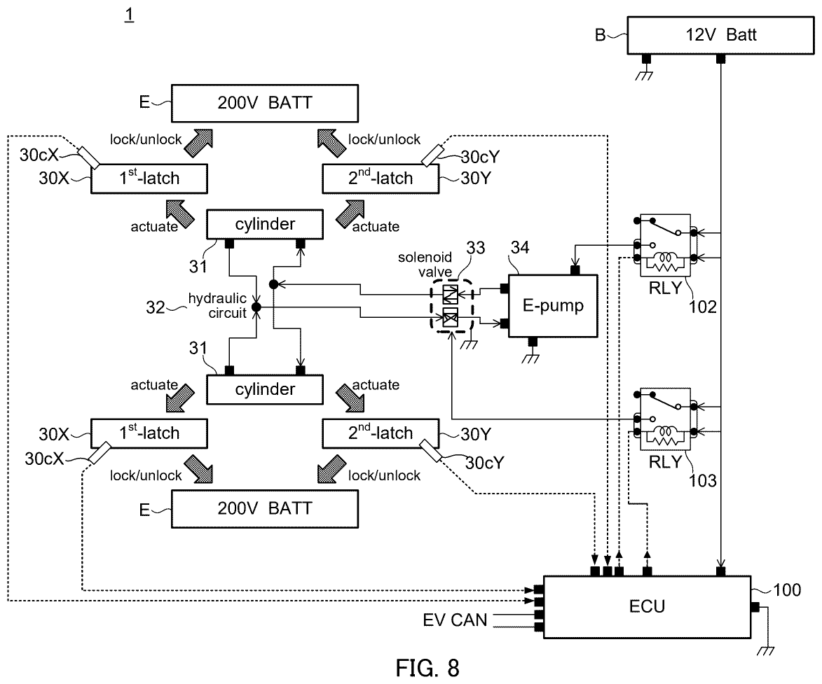

FIG. 6 is a diagram illustrating an example of a configuration of battery E. FIG. 7 is a diagram illustrating an example of a configuration of lock switch 30cX and unlock switch 30cY provided in lock mechanisms 30X and 30Y. FIG. 8 is a diagram illustrating an example of a configuration of a driving section of lock mechanisms 30X and 30Y.

Battery attachment apparatus 1 includes two lock mechanisms 30X and 30Y for attaching battery E to vehicle frame Cf. Two lock mechanisms 30X and 30Y are disposed at a first attachment position and a second attachment position of a storage part in which battery E is stored along the front-rear direction of vehicle frame Cf, and are fixed to vehicle frame Cf via a bracket or the like (hereinafter, abbreviated). Then, two lock mechanisms 30X and 30Y fix battery E to vehicle frame Cf at the first attachment position and the second attachment position, respectively. Hereinafter, two lock mechanisms 30X and 30Y will be referred to as “first lock mechanism 30X” and “second lock mechanism 30Y”, respectively.

First lock mechanism 30X engages with first striker EbX attached to the side surface of battery E, thereby fixing battery E to vehicle frame Cf at the first attachment position. Second lock mechanism 30Y engages with second striker EbY attached to the side surface of battery E, thereby fixing battery E to vehicle frame Cf at the second attachment position. Here, as illustrated in FIG. 6, first striker EbX and second striker EbY are, for example, rod-like members that are attached to the side surface of battery E with battery bracket Ea such that first striker EbX and second striker EbY extend in the +Z direction at positions protruding from the side surface side of battery E.

First and second lock mechanisms 30X and 30Y are constituted by, for example, a pair of latches 30aX and 30a Y paired along the front-rear direction (+X direction) of vehicle frame Cf. Then, first and second lock mechanisms 30X and 30Y are driven by, for example, in-vehicle actuator 31 (here, a hydraulic cylinder) to operate in conjunction with each other. Hereinafter, latch 30aX of first lock mechanism 30X will be referred to as “first latch 30aX”, and latch 30aY of second lock mechanism 30Y will be referred to as “second latch 30aY.”

When accommodating battery E in vehicle C, first and second lock mechanisms 30X and 30Y hold a locked state in which battery E is fixed to vehicle frame Cf. Further, when exchanging battery E, first and second lock mechanisms 30X and 30Y release the locked state between battery E and vehicle frame Cf.

First and second latches 30aX and 30aY are hook members that are supported rotatably around the Z-axis with respect to vehicle frame Cf and caught by first and second strikers EbX and EbY. Each of first and second latches 30aX and 30aY rotates around the Z-axis in conjunction with the operation of in-vehicle actuator 31 (here, a hydraulic cylinder). Note that FIGS. 3, 4, and 5 illustrate other views illustrating the configuration and the operation state of second latch 30aY as viewed from the side opposite to the present drawing (that is, views from the minus Z direction side), but the configuration and the operation state of first latch 30aX are the same as the configuration and the operation state of latch 30aY.

When locking battery E to vehicle frame Cf, first latch 30aX rotates counterclockwise around the Z-axis to engage with first striker EbX on the battery E side and fix battery E to vehicle frame Cf. When locking battery E to vehicle frame Cf, second latch 30a Y rotates counterclockwise around the Z-axis to engage with second striker Eb Y on the battery E side and fix battery E to vehicle frame Cf. Note that, when first latch 30aX and second latch 30a Y engage with first and second strikers EbX and EbY on battery E side to fix battery E to vehicle frame Cf, they operate to pull battery E to vehicle frame Cf side (plus Y direction) (see FIG. 5). Thus, battery E is fixed to vehicle frame Cf with no rattling with battery bracket Ea pressed against rubber member 30e serving as a stopper fixed to vehicle frame Cf side.

Further, when unlocking battery E from vehicle frame Cf, first and second latches 30aX and 30aY rotate clockwise around the Z-axis, releasing the engaged state with first and second strikers EbX and EbY, respectively, on the battery E side, and allowing battery E to be removed from vehicle frame Cf (see FIG. 3).

Note that, in the present embodiment, as illustrated in FIGS. 3, 4, and 5, second latch 30aY is directly connected to in-vehicle actuator 31, and first latch 30aX is connected to in-vehicle actuator 31 via link rod 30b. Thus, first latch 30aX and second latch 30aY are configured to operate in conjunction with each other.

In-vehicle actuator 31 is, for example, a hydraulic cylinder. At the time of locking and unlocking, in-vehicle actuator 31 operates the piston along the +X direction to operate link rod 30b connected to itself to swing along the +X direction. Specifically, in-vehicle actuator 31 operates the piston to extend along the +X direction when locking, and in-vehicle actuator 31 operates the piston to return to the initial state when unlocking. Thus, first and second latches 30aX and 30aY rotate counterclockwise around the Z-axis when locking, and engage with first and second strikers EbX and EbY, respectively, on battery E side when unlocking. Further, first and second latches 30aX and 30aY rotate clockwise around the Z-axis when unlocking, releasing the engaged state with first and second strikers EbX and EbY, respectively, on battery E side.

As illustrated in FIG. 8, in-vehicle actuator 31 is configured to be driven by hydraulic circuit 32 connected to in-vehicle actuator 31, drive pump 34 that supplies operating oil to hydraulic circuit 32, and control valve 33 disposed in hydraulic circuit 32, for example. That is, drive pump 34 sends high-pressure operating oil to hydraulic circuit 32, and control valve 33 controls the supply state of the operating oil to in-vehicle actuator 31. Thus, in-vehicle actuator 31 (hydraulic cylinder) operates the piston by converting the fluid energy of the hydraulic oil into mechanical energy.

Note that the operation state of in-vehicle actuator 31 is controlled by ECU 100. ECU 100 is, for example, a microcontroller including a central processing unit (CPU), a read only memory (ROM), a random access memory (RAM), an input port, an output port, a communication module, and the like. ECU 100 controls the opening and closing states of first relay 102 and second relay 103, thereby controlling the supply of operating power from auxiliary battery B (a low-voltage battery that supplies operating power to an on-board electrical component mounted on vehicle C) to drive pump 34 and control valve 33, and controlling the operations of drive pump 34 and control valve 33, for example. Note that ECU 100 corresponds to the “control section” of the present invention.

Battery attachment apparatus 1 according to the present embodiment is especially characterized in that it has a state monitoring function using lock switch 30cX and unlock switch 30cY for ensuring safety during battery exchange (see FIGS. 3 to 5).

Lock switch 30cX, disposed in first lock mechanism 30X, senses the operation of first lock mechanism 30X, and detects the lock completion of battery E based on the operation state of first lock mechanism 30X.

Unlock switch 30cY, disposed in second lock mechanism 30Y, senses the operation of second lock mechanism 30Y, and detects the unlock completion of battery E based on the operation state of second lock mechanism 30Y.

Here, lock switch 30cX and unlock switch 30cY are each constituted by, for example, a contact-type switch (see FIG. 7). The contact-type switch includes, for example, push button part BS, and senses a pushing operation to push button part BS from the outside. Such a contact-type switch is, for example, turned ON when push button part BS is pushed in by a predetermined amount from the reference position.

In the contact-type switch according to the present embodiment, the stroke range of push button part BS is set to 11 mm, and the switch ON range of push button part BS is set to 9 mm. That is, the contact-type switch according to the present embodiment is switched ON when push button part BS is pushed in by 2 mm or more from the reference position (initial position), and is switched OFF when the push-in amount is less than 2 mm. Lock switch 30cX and unlock switch 30c Y each send a switch ON signal to ECU 100 when switched ON.

In the present embodiment, first lock mechanism 30X includes first bracket 30dX that pushes lock switch 30cX when the locking is completed by operating in conjunction with the operation of first lock mechanism 30X. Specifically, first bracket 30dX is fixed to the first end side of link rod 30b (that is, the position of the link part on the minus X-direction side of link rod 30b). The position of the link part of link rod 30b on the minus X-direction side is a position that serves as the operation starting point of first lock mechanism 30X, and first bracket 30dX operates in conjunction with the operation of first lock mechanism 30X along with the swinging motion of link rod 30b.

Note that, in the present embodiment, first bracket 30dX extends in the plus Y direction from the first end side of link rod 30b, and a button contact part is formed at the end portion in the plus Y direction. Further, lock switch 30cX is disposed with push button part BS directed in the minus Y direction. First bracket 30dX operates to draw an arc in conjunction with the swinging motion of link rod 30b, and upon completion of locking of first lock mechanism 30X, the button contact part at the end portion in the plus Y direction presses push button part BS of lock switch 30cX (see FIG. 5).

Further, second lock mechanism 30 includes second bracket 30dY that pushes unlock switch 30cY in response to the unlock completion by operating in conjunction with the operation of second lock mechanism 30Y. Specifically, second bracket 30dY is fixed to the second end side of link rod 30b (that is, the position of the link part on the plus X-direction side of link rod 30b), and operates in conjunction with the swinging motion of link rod 30b. The position of the link part of link rod 30b on the plus X-direction side is a position that serves as the operation starting point of second lock mechanism 30Y, and second bracket 30dY operates in conjunction with the operation of second lock mechanism 30Y along with the swinging motion of link rod 30b.

Note that, in the present embodiment, second bracket 30dY extends from the second end side of link rod 30b in the plus Y direction, and a button contact part is formed at the end portion in the plus Y direction. Further, unlock switch 30cY is disposed with push button part BS directed in the minus X direction. Second bracket 30dY operates to draw an arc in conjunction with the swinging motion of link rod 30b, and upon completion of unlocking of second lock mechanism 30Y, the button contact part at the end portion in the plus Y direction presses push button part BS of unlock switch 30cY (see FIG. 3).

Here, the operation states of first and second lock mechanisms 30X and 30Y are determined by, for example, ECU 100. That is, ECU 100 acquires the sensor signals (that is, switch ON signals) of lock switch 30cX and unlock switch 30cY, and determines which of the three states, namely, the lock completion state, the transition state between the lock state and the unlock state, and the unlock completion state, the current state is on the basis of the sensor signals of lock switch 30cX and unlock switch 30cY.

Here, ECU 100 generates a fault occurrence signal related to the operation of first and second lock mechanisms 30X and 30Y in a case where the operations of first and second lock mechanisms 30X and 30Y are completed (that is, the operation of in-vehicle actuator 31 is completed) but the sensor signals of lock switch 30cX and unlock switch 30cY each suggest that first and second lock mechanisms 30X and 30Y are in a “transition state”.

Then, ECU 100 transmits the fault occurrence signal to the system on the battery exchange station side. In a case where the system on the battery exchange station side receives a fault occurrence signal, the system stops the operation of the battery exchanger. This prevents a situation where the battery exchange machine operates as usual to forcibly pull out the half-locked battery from the vehicle even though there is a failure in first and second lock mechanisms 30X and 30Y.

Hereinafter, an exemplary operation flow of ECU 100 will be described.

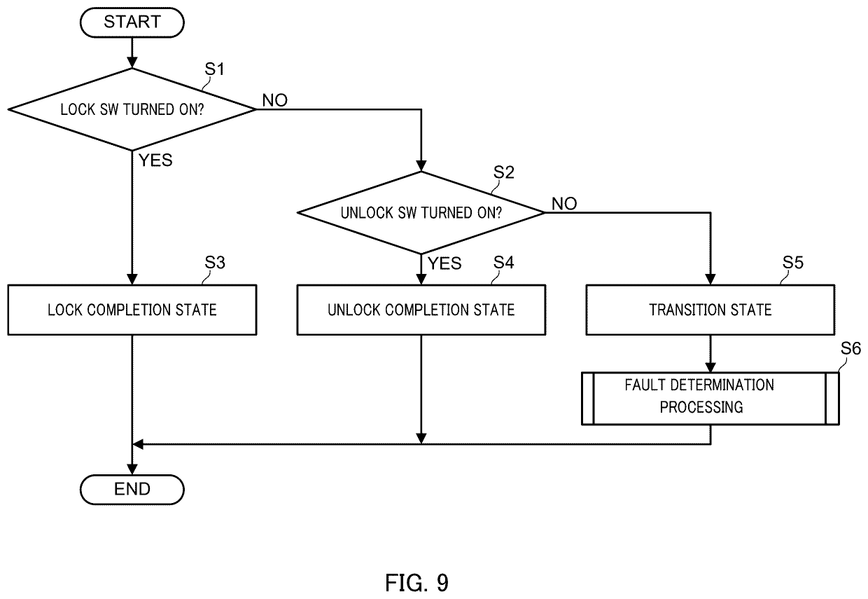

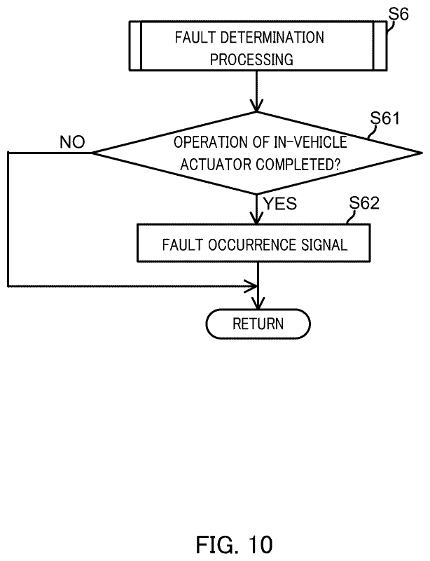

FIGS. 9 and 10 are diagrams illustrating an example of an operation procedure of ECU 100. The flowcharts illustrated in FIGS. 9 and 10 illustrate processes repeatedly executed by ECU 100 at predetermined intervals (for example, every 100 msec) in accordance with a computer program, for example.

In step S1, ECU 100 determines whether lock switch 30cX is in the ON state. In a case where lock switch 30cX is in the ON state (S1: YES), ECU 100 advances the process to step S3, and in a case where lock switch 30cX is not in the ON state (S1: NO), ECU 100 advances the process to step S2.

In step S2, ECU 100 determines whether unlock switch 30cY is in the ON state.

In a case where unlock switch 30cY is in the ON state (S2: YES), ECU 100 advances the process to step S4, and in a case where unlock switch 30cY is not in the ON state (S2: NO), ECU 100 advances the process to step S5.

In step S3, ECU 100 determines that the holding state of battery E is in a lock completion state.

In step S4, ECU 100 determines that the holding state of battery E is the unlock completion state.

In step S5, ECU 100 determines that the holding state of battery E is a transition state between the locked state and the unlocked state. In this case, there is a possibility that a failure has occurred in first and second lock mechanisms 30X and 30Y, and thus, ECU 100 performs the processing in the subsequent step S6.

In step S6, ECU 100 performs the fault determination processing illustrated in FIG. 10.

In step S61, ECU 100 determines whether the operation of in-vehicle actuator 31 has been completed. In a case where the operation of in-vehicle actuator 31 has been completed (S61: YES), ECU 100 advances the process to step S62, and in a case where the operation of in-vehicle actuator 31 has not been completed (S61: NO), the process in the flowchart of FIG. 10 is terminated without performing any particular processing.

In step S62, ECU 100 determines that a failure has occurred in first and second lock mechanisms 30X and 30Y, and generates a fault occurrence signal. ECU 100 transmits this fault occurrence signal to a system on the battery exchange station side.

In this manner, ECU 100 consecutively acquires the sensor signals from lock switch 30cX and unlock switch 30cY to monitor the holding state of battery E (that is, the operation state of first and second lock mechanisms 30X and 30Y). Thus, ECU 100 is capable of detecting a situation where a failure has occurred in first and second lock mechanisms 30X and 30Y.

### Effects

As described above, battery attachment apparatus 1 according to the present embodiment includes: the first lock mechanism and the second lock mechanism that are disposed at the first and second attachment positions of the storage part (vehicle frame Cf in the above-described embodiment) in which the battery is stored to operate in conjunction with each other and fix the battery to the storage part. The first lock mechanism includes the first sensor (lock switch 30cX in the above-described embodiment) that senses the operation of the first lock mechanism and detects the lock completion of the battery based on the operation state of the first lock mechanism. The second lock mechanism includes the second sensor (unlock switch 30cY in the above-described embodiment) that senses the operation of the second lock mechanism and detects the unlock completion of the battery based on the operation state of the second lock mechanism.

Thus, according to battery attachment apparatus 1 of the present embodiment, it is possible to accurately determine the holding state of battery E, and to accurately detect the occurrence of a failure state in first and second lock mechanisms 30X and 30Y.

Thus, for example, even in a case where some failure occurs in first and second lock mechanisms 30X and 30Y during unlocking (for example, in a case where in-vehicle actuator 31 stops halfway), it is possible to stop the battery exchange machine from forcibly pulling out the half-locked latch.

The present invention is not limited to the above-described embodiments, and can be applied to various modifications.

For example, in the above-described embodiment, an example of battery attachment apparatus 1 has been described in which battery E is slidable between the battery storage position and the battery attachment/detachment position on slide rail base 20, but the configuration for supporting battery E is not limited in the present invention.

Further, in the above-described embodiment, a pair of latches 30aX and 30aY is described as an example of lock mechanisms 30X and 30Y. However, lock mechanisms 30X and 30Y used in the present invention are optional, and other lock mechanisms may be used.

Although the specific examples of the present invention have been described in detail above, the specific examples are merely examples and do not limit the scope of the claims. The technology described in the claims includes various modifications and variations of the specific examples illustrated above.

This application is entitled to and claims the benefit of Japanese Patent Application No. 2024-73919 filed on Apr. 30, 2024, the disclosure each of which including the specification, drawings and abstract is incorporated herein by reference in its entirety.

### INDUSTRIAL APPLICABILITY

According to the battery attachment apparatus of the present invention, it is possible to accurately determine the holding state of the battery.

### REFERENCE SIGNS LIST

1 Battery attachment apparatus
10 Mounting table
20 Slide rail base
30X, 30Y Lock mechanism
30aX, 30aY Latch
30b Link rod
30cX Lock switch (First sensor)
30cY Unlock switch (second sensor)
30dX First bracket
30dY Second bracket
30e Rubber member
31 In-vehicle actuator
32 Hydraulic circuit
33 Control valve
34 Drive pump
100 ECU
102 First relay
103 Second relay
C Vehicle
Cf Vehicle frame
E Battery
Ea Battery bracket
EbX, EbY Striker
Ec Terminal part

1. A battery attachment apparatus, comprising:
a first lock mechanism and a second lock mechanism disposed at a first attachment position and a second attachment position of a storage part in which a battery is stored, and configured to operate in conjunction with each other to fix the battery to the storage part,
wherein the first lock mechanism includes a first sensor configured to sense an operation of the first lock mechanism and detect a lock completion of the battery based on an operation state of the first lock mechanism; and
wherein the second lock mechanism includes a second sensor configured to sense an operation of the second lock mechanism and detect an unlock completion of the battery based on an operation state of the second lock mechanism.

2. The battery attachment apparatus according to claim 1, wherein each of the first sensor and the second sensor is constituted by a contact-type switch.

3. The battery attachment apparatus according to claim 2,
wherein the first lock mechanism includes a first bracket configured to operate in conjunction with the operation of the first lock mechanism and turn on the first sensor in response to a lock completion of the first lock mechanism; and
wherein the second lock mechanism includes a second bracket configured to operate in conjunction with the operation of the second lock mechanism and turn on the second sensor in response to an unlock completion of the second lock mechanism.

4. The battery attachment apparatus according to claim 1,
wherein the first lock mechanism includes a first latch configured to engage with a first stringer attached to the battery;
wherein the second lock mechanism includes a second latch configured to engage with a second stringer attached to the battery; and
wherein the first latch and the second latch are connected to each other by a link mechanism and operate in conjunction with each other.

5. The battery attachment apparatus according to claim 1, further comprising a control section configured to acquire a sensor signal of each of the first sensor and the second sensor, and determine whether a holding state of the battery is a lock completion state, an unlock completion state, or a transition state of a lock operation based on the sensor signal of each of the first sensor and the second sensor.

6. The battery attachment apparatus according to claim 5, wherein when the holding state of the battery is the transition state of the lock operation even though a driving section of the first lock mechanism and the second lock mechanism is in an operation completion state, the control section generates a fault occurrence signal related to the operation of the first lock mechanism and/or the second lock mechanism.

7. A vehicle comprising the battery attachment apparatus according to claim 1.
